(19) United States
(12) Patent Application Publication
(10) Pub. No.: US 2023/0044118 A1
(43) Pub. Date: Feb. 9, 2023

(54) ELECTRONIC EQUIPMENT FOR INPUT OF PASSWORDS AND BIOMETRIC DATA OF BANK CUSTOMERS IN COMMERCIAL ESTABLISHMENTS

(71) Applicant: TECNOLOGIA BANCÁRIA S.A., Barueri (BR)

(72) Inventor: Sidney Rufca, Sao Paulo (US)

(21) Appl. No.: 17/817,262

(22) Filed: Aug. 3, 2022

(30) Foreign Application Priority Data
Aug. 4, 2021 (BR) 102021015378-4

(51) Int. Cl. G06Q 20/40

(52) U.S. Cl. CPC G06Q 20/40145

(57) ABSTRACT

This patent features a self-servicing electronic equipment (1) for use preferably in commercial establishments, which enables performing bank transactions and cash withdrawals in which the financial operation is performed by the electronic equipment (1) and the cash is provided by the commercial establishment. The electronic equipment (1) includes a central processing unit (14) for control and connection between devices. The electronic equipment (1) comprises a cabinet (2), including a structural part made of a thermoplastic material, comprising an upper part (21), a lower part (22), side finishing parts (23) and side closure parts (24), fingerprint reader support (16), palm vein reader support (15), external connector support (18), central processing unit support (17) and card reading and password input device support (19), internal processing center (14), card reading and password input device (3), fingerprint reader (5), palm vein reader (13), fixed base (20) and base with rotating system (10).

This application claims priority under 35 U.S.C. § 119 to Brazilian Application No. 102021015378-4 filed Aug. 4, 2021. The contents of the aforementioned application are incorporated herein by reference.

### FIELD OF APPLICATION

This specification describes an invention patent application for an electronic equipment used for input of passwords and biometric data of bank customers in commercial establishments.

### STATE OF THE ART

The state of the art has the automatic teller machines, ATMs, as the equipment that enable cash withdrawals and transactions to bank customers.

### PROBLEMS WITH THE STATE OF THE ART

The main tool available for cash withdrawals and transactions to bank customers are the automatic teller machines; however, due to safety restrictions, logistics and cost, many locations end up lacking self-service solutions, many times with no access to automatic teller machines.

Nowadays, there is no compact and cashless equipment that enables bank customers to perform operations, bank transactions and cash withdrawal using hardware devices with biometry authentication as safety and validation factors, which provide the same experience and safety that is inherent to automatic teller machines.

### OBJECTIVES OF THE INVENTION

Allowing easy access to the functions of an automatic teller machine in commercial spots in an equipment with reduced size, lower production cost, easy deployment, and installation.

Providing the main functions of an automatic teller machine for a larger share of the population in places where the current solution of the state of the art, the automatic teller machines, cannot be implemented.

### BRIEF DESCRIPTION OF THE INVENTION

In face of the problems of the state of the art, a compact equipment was developed to be implemented in commercial establishments, which enables bank customers to perform cash withdrawals, in particular, with no need for extended travel times. The electronic equipment proposed herein performs, accesses, and controls all transactions, while the commercial establishment is in charge of the cash in withdrawal operations.

The equipment proposed herein includes user authentication devices through biometry, which are peripherals intended to ensure the recognition of each individual from specific physical characteristics without faults and with total safety during bank operation.

For the compatibility with the current banking system, the equipment has two systems for user authentication and checking, one by digital data capture from the fingers (fingerprint) and another by the capture of the pattern of veins in the hand palm (palm vein).

The equipment has an embedded device for card reading, password typing and navigation and selection of transaction options, commonly called pin pad device or POS device.

### ADVANTAGES OF THE INVENTION REGARDING THE STATE OF THE ART

The equipment has the main functions of an automatic teller machine, but with reduced cost and size.

The equipment may be transported and installed on hard-to-reach locations due to its reduced size.

The equipment has biometry safety devices that ensure users and banks the safety in transactions.

The equipment has no vault or cash storage drawers.

### BRIEF DESCRIPTION OF THE DRAWINGS

In order to complement this description to better understand the characteristics of the equipment proposed herein and according to a preferred practical embodiment thereof, attached to the description is a set of drawings that, in an exemplified manner, although not limiting, is represented as follows:

FIG. 1 shows a perspective front view of the equipment;

FIG. 2 shows a forward perspective view of the equipment;

FIG. 3 shows a perspective lower view of the equipment;

FIG. 4 shows the upper view with details of the hand holder and palm vein reader;

FIGS. 5A and 5B show details of the rotating base system;

FIG. 6 shows a perspective exploded view of the equipment;

FIG. 7 shows a block diagram with communications and connections of the main devices.

### DETAILED DESCRIPTION OF THE INVENTION

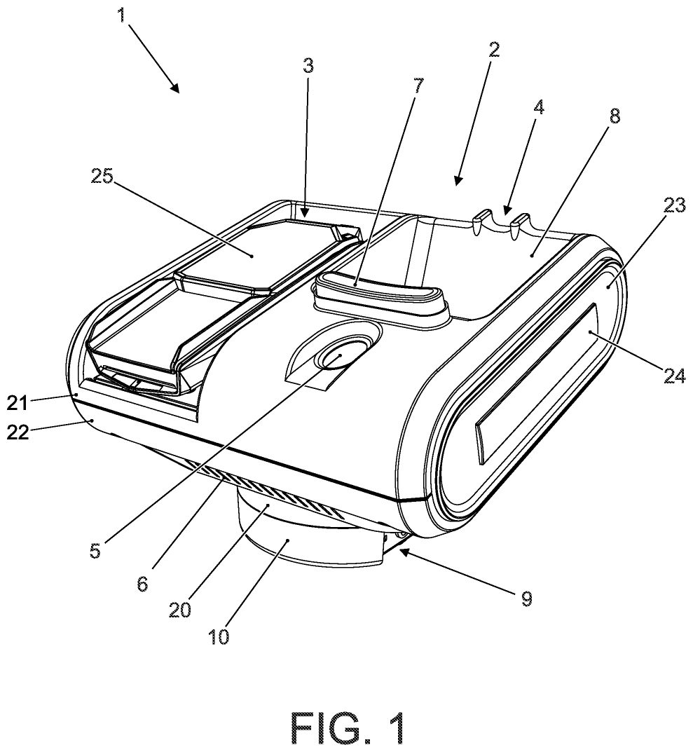

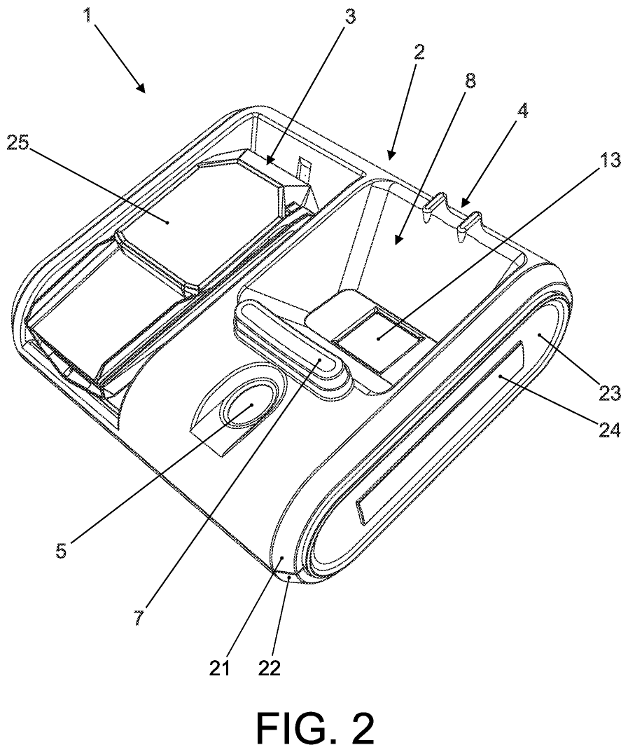

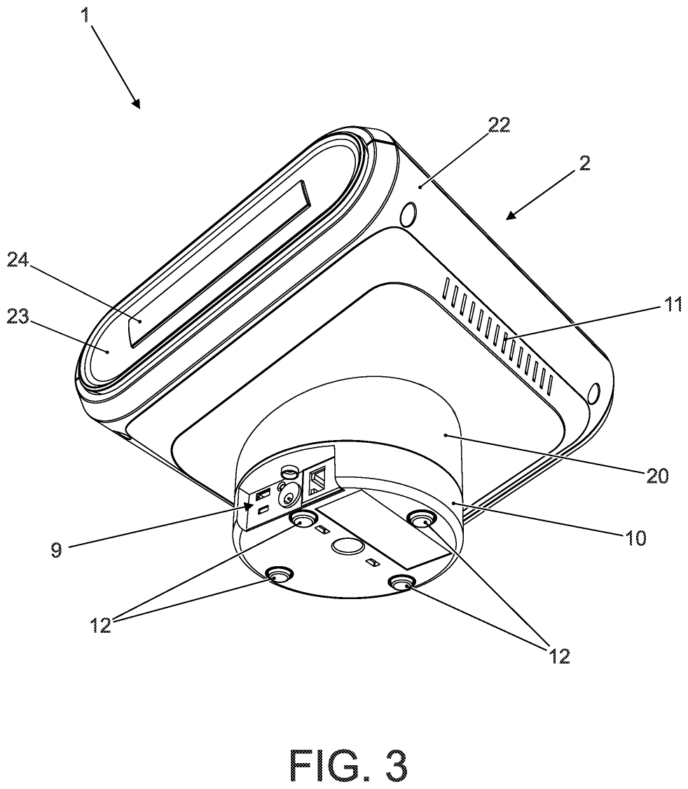

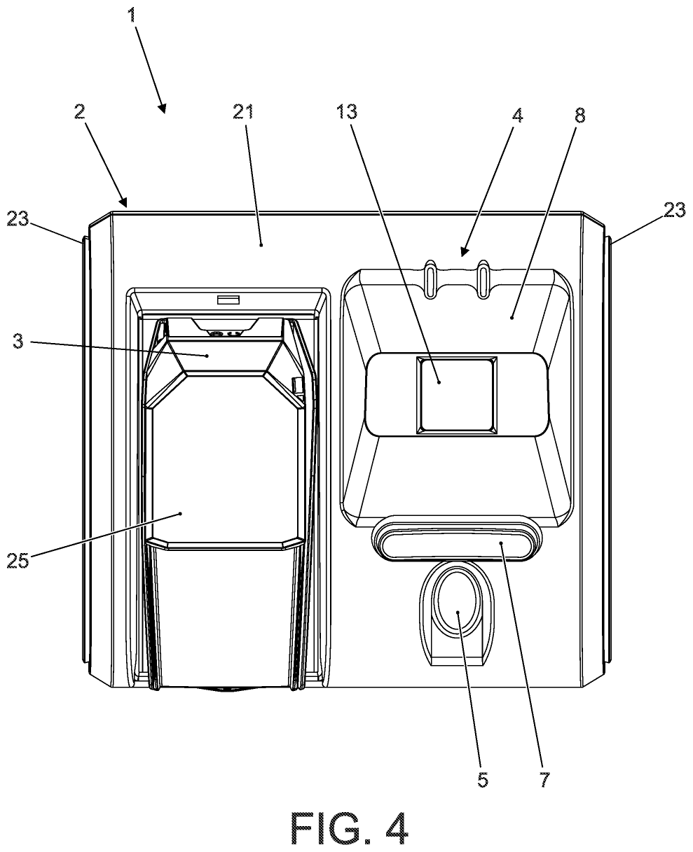

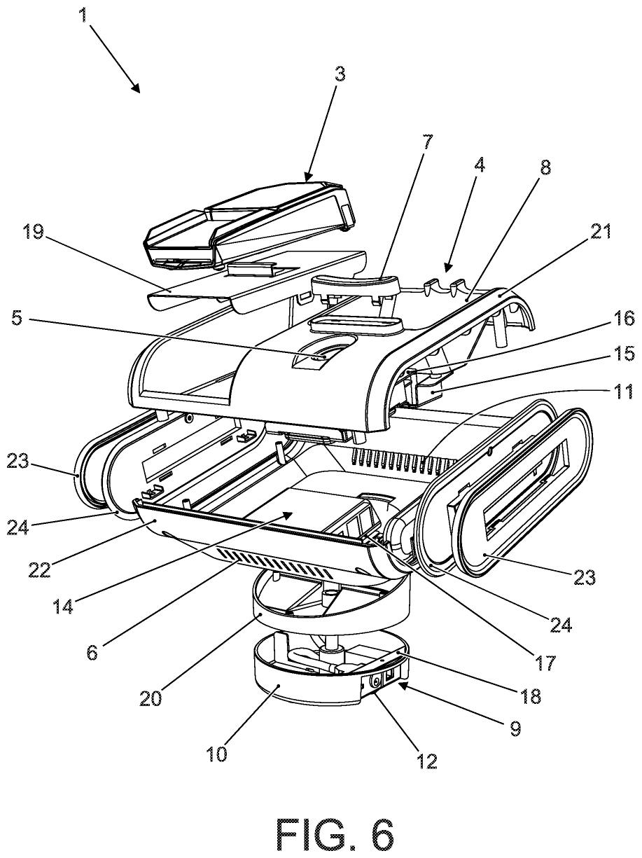

The electronic equipment 1, represented by the front isometric perspective view in FIG. 1 and the exploded view in FIG. 6, was developed to be positioned on a table, service counter or supermarket cashier with no need for a physical installation or mechanical fastening, and may easily be moved around in the commercial establishment according to user needs.

### PREFERRED MODE FOR CARRYING OUT THE INVENTION

The electronic equipment 1 comprises: a cabinet 2, including a structural part made of a thermoplastic material, comprising an upper part 21, a lower part 22, side finishing parts 23 and side closure parts 24, in addition to metallic supports for fastening components such as: fingerprint reader support 16, palm vein reader support 15, external connector support 18, central processing unit support 17 and card reading and password input device support 19, central processing unit 14, card reading and password input device 3, fingerprint reader 5, palm vein reader 13, fixed base 20 and base with rotating system 10.

The cabinet 2 is the structural part responsible for integrating all devices and peripherals of the electronic equipment 1. The cabinet 2 is also responsible for powering the components, through an external electric power source 26, fed through an AC current. In order to ensure correct functioning and avoiding heat issues, there are front openings 6 and rear openings 11 for convection ventilation.

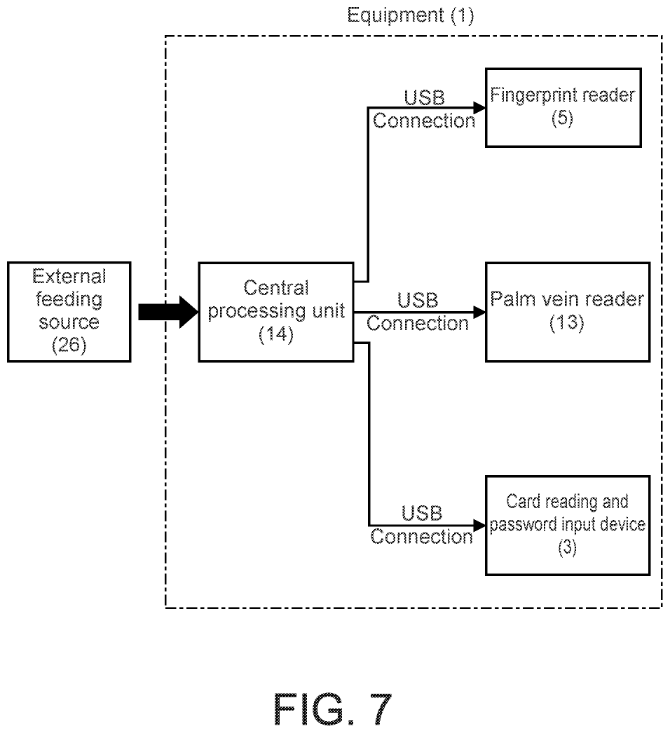

The central processing unit 14 is the device responsible for controlling and connecting all devices of the electronic equipment 1, in addition to its functions. This electronic equipment 1 is a complete data processing system, including a central processing unit 14 with Arm or X86 instructions, RAM (Random Access Memory) and permanent data storage. It has all interfaces for external communication and internal connectivity, such as demonstrated by FIG. 7. The central processing unit 14 is also responsible for connecting the electronic equipment 1 to the external feed network.

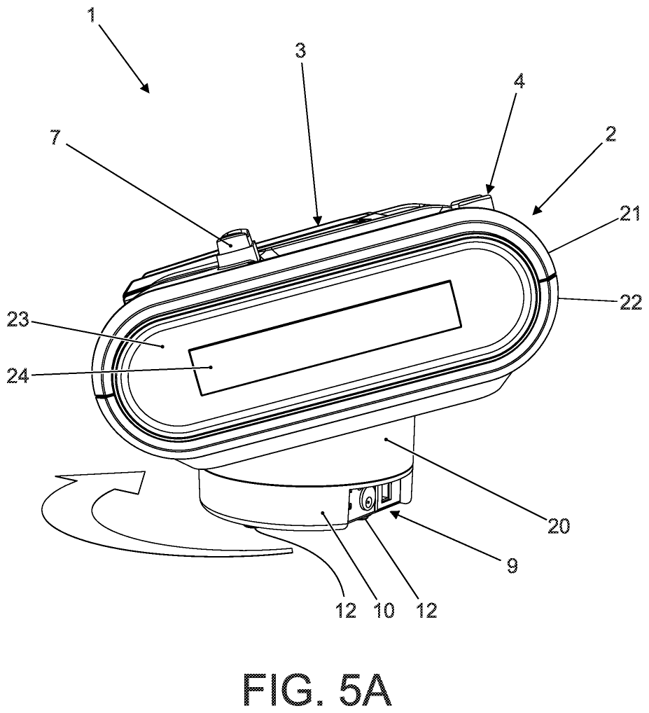

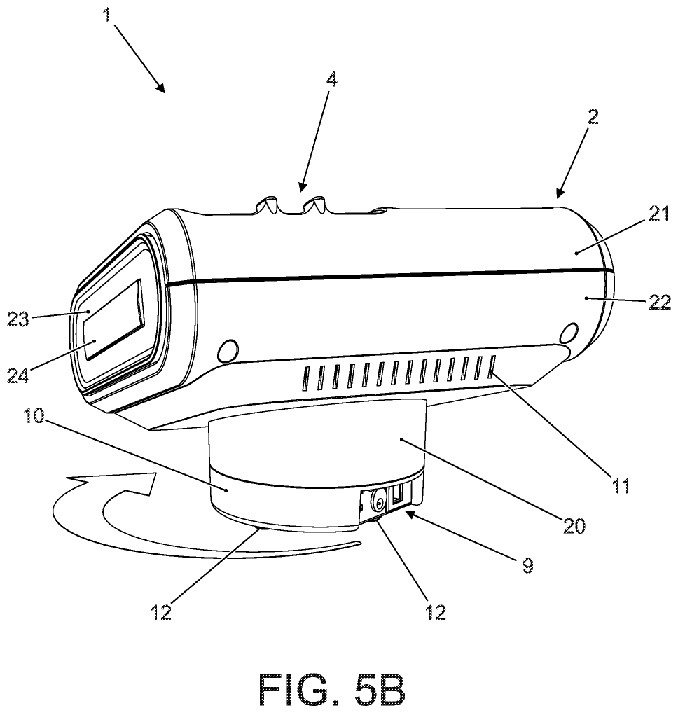

The electronic equipment 1 has a rotating system, illustrated by FIG. 5, which allows clockwise and counterclockwise rotation up to 90°. This rotation is performed through a base with a rotating system 10 and rubber feet 12 to facilitate use and help in product ergonomics. The base with rotating system 10 holds the panel 9 for external connections and feeding.

The card reading and password input device 3 is the interface between the user and the electronic equipment 1, and all options of navigation and selection are performed through this device. There is a touchscreen 25 with the options for choice, and the desired option is selected by using scroll keys or through the touchscreen 25. The card reading and password input device 3 is also able to read magnetic cards, smart cards or apply proximity technology. This card reading and password input device 3 connects to the central processing unit 14 through a USB communication port.

The fingerprint reader 5 is characterized by the identification and validation of the user in the transaction to be performed, by comparing the fingerprint with the image previously stored in a server, thus preventing frauds to be committed by unauthorized people. The fingerprint reader 5, for recognition of fingerprints, connects to the central processing unit 14 through a USB communication port.

The palm vein reader 13 is characterized by the identification and validation of the user in the transaction to be performed, by comparing the information with the image previously stored in a server, thus preventing frauds by unauthorized people. This palm vein reading device 13 connects to the central processing unit 14 through a USB communication port. For correct reading of the palm vein reader 13, the electronic equipment 1 has a finger guide 4, wrist support 7 and a biometric holder 8 guiding and ensuring ergonomics for correct utilization.

The electronic equipment 1 follows a defined and sequential procedure for operation, choosing the transaction types and options desired by the card reading and password input device 3 through the function keys or the touchscreen 25.

In cash withdrawals or bank transactions, the touchscreen 25 of the card reading and password input device 3 requests confirmation of the start of operation, which leads to the selection of the operation type. Then, card insertion or swiping on the card reading and password input device 3 is requested; after said reading, confirmation and data processing, safety validations will be requested, which may vary according to the policies of each financial institution. This validation may occur through a password inserted through the card reading and password input device 3 and/or by biometry through the fingerprint reading device 5 or palm vein reader 13. All information are shown on the touchscreen 25 of the card reading and password input device 3, such as safety verifications of biometry reading devices 5 and 13, in addition to communication of internal and external data of the electronic equipment 1 being controlled by the central processing unit 14. Internal connections between the central processing unit 14 and the fingerprint reading devices 5, palm vein reader 13 and card reading and password input device 3 are represented in FIG. 7.

1. “ELECTRONIC EQUIPMENT FOR INPUT OF PASSWORDS AND BIOMETRIC DATA OF BANK CUSTOMERS IN COMMERCIAL ESTABLISHMENTS”, wherein the electronic equipment (1) comprises: a cabinet (2), including an upper part (31), a lower part (22), side finishing parts (23) and side closure parts (24); fingerprint reader support (16), palm vein reader support (15), external connector support (18), central processing unit support (17), card reading and password input device support (19), central processing unit (14), card reading and password input device (3) including touchscreen (25), fingerprint reader (5), palm vein reader (13), fixed base (20) and base with rotating system (10) with rubber feet (12); the base with rotating system (10) has a panel (9) for external connections and feeding; the cabinet (2) is provided with front openings (6) and rear openings (11); the central processing unit (14) contains ARM or X86 instructions, random access memory (RAM) and permanent data storage.

2. “ELECTRONIC EQUIPMENT FOR INPUT OF PASSWORDS AND BIOMETRIC DATA OF BANK CUSTOMERS IN COMMERCIAL ESTABLISHMENTS”, according to claim 1, wherein it comprises the bank transaction of cash withdrawal in the commercial establishment in which the electronic equipment (1) performs the transaction and clearance by the financial institution and the commercial establishment delivers the cash to the bank customer.

3. “ELECTRONIC EQUIPMENT FOR INPUT OF PASSWORDS AND BIOMETRIC DATA OF BANK CUSTOMERS IN COMMERCIAL ESTABLISHMENTS”, according to claim 1, the electronic equipment (1) including a biometry and safety system with input of password and biometric data of bank customers in commercial establishments, wherein it performs and authorizes bank transactions using biometry authentication through the fingerprint reader (5) or palm vein reader (13) as a safety factor.

4. “ELECTRONIC EQUIPMENT FOR INPUT OF PASSWORDS AND BIOMETRIC DATA OF BANK CUSTOMERS IN COMMERCIAL ESTABLISHMENTS”, according to claim 2, the electronic equipment (1) including a biometry and safety system with input of password and biometric data of bank customers in commercial establishments, wherein it performs and authorizes bank transactions using biometry authentication through the fingerprint reader (5) or palm vein reader (13) as a safety factor.

5. “ELECTRONIC EQUIPMENT FOR INPUT OF PASSWORDS AND BIOMETRIC DATA OF BANK CUSTOMERS IN COMMERCIAL ESTABLISHMENTS”, according to claim 1, wherein the cabinet (2) provides electric power to components through an external electric power source (26), fed through an AC current.
